(19) United States
(12) Patent Application Publication
(10) Pub. No.: US 2017/0068683 A1
(43) Pub. Date: Mar. 9, 2017

(54) CONTEXT BASED INSTANT SEARCH SUGGESTIONS

(71) Applicant: Google Inc., Mountain View, CA (US)

(72) Inventors: Dhruv Bakshi, Zurich (CH); Jakob Nicolaus Foerster, Zurich (CH)

(21) Appl. No.: 14/846,100

(22) Filed: Sep. 4, 2015

(51) Int. Cl. G06F 17/30

(52) U.S. Cl. CPC G06F 17/3097; G06F 17/30424; G06F 17/30867; G06F 17/30345

(57) ABSTRACT

Methods, systems, and apparatus for receiving, during a search session, a request for a suggested search query; in response to receiving the request for a suggested search query: selecting a query pattern from a query pattern database; identifying an entity that is associated with one or more search queries received during the search session; generating a suggested search query based on the selected query pattern and the identified entity; and providing data that causes the generated suggested search query to be presented in a user interface.

### TECHNICAL FIELD

This specification relates to search engines.

### BACKGROUND

In general, a user can request information by inputting a query to a search engine. The search engine can process the query and can provide information for output to the user in response to the query.

### SUMMARY

A system can receive requests for suggested search queries during a search session. In response to the request, the system can generate suggested search queries based on identifying one or more entities, e.g., singers, actors, musicians, writers, directors, television networks, or other production companies, that are associated with one or more search queries received during the search session. The system uses the recent search queries received during the search session as context terms to bias the scoring of potential suggested search queries towards places, people, or any entities that can be extracted from the search session.

Innovative aspects of the subject matter described in this specification may be embodied in methods that include the actions of receiving, during a search session, a request for a suggested search query; in response to receiving the request for a suggested search query: selecting a query pattern from a query pattern database; identifying an entity that is associated with one or more search queries received during the search session; generating a suggested search query based on the selected query pattern and the identified entity; and providing data that causes the generated suggested search query to be presented in a user interface.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations the methods may include identifying a set of entities referenced by one or more search queries received during the search session; for each entity in the set of entities, identifying one or more entities that are related to the entity; expanding the set of entities to include the entities that are related to each entity in the set of entities; and storing, in a buffer, the expanded set of entities, wherein the entity is identified from among the expanded set of entities stored in the buffer.

In some implementations the methods may include, for each entity in the expanded set of entities, assigning a relevance score to the entity.

In other implementations, identifying an entity that is associated with one or more search queries received during the search session comprises: identifying an entity type matching a placeholder type in the selected query pattern; and identifying an entity that (i) has the identified entity type, and (ii) is associated with one or more search queries received during the search session.

In some cases, identifying an entity that (i) has the identified entity type, and (ii) is associated with one or more search queries received during the search session comprises: accessing, by the buffer, the expanded set of entities; selecting a set of entities that have the identified entity type; selecting an entity from the set of entities based on the scores of each entity in the set of entities that have the identified entity type.

In some implementations the request for the suggested search query comprises a partial search query that includes one or more characters input by a user.

In other implementations the request for the suggested search query does not include any characters input by a user.

In some cases selecting the query pattern comprises: determining that the partial search query matches a portion of a query pattern stored in a query pattern database; and selecting the query pattern stored in the query pattern database.

In other cases, selecting the pattern comprises: identifying one or more recent query patterns input during the search session; determining that one or more of the identified recent query patterns are related to a predetermined list of entities; and selecting the query pattern that is determined to be related to the predetermined list of entities.

In some implementations the list of entities is an ordered list of entities.

In some implementations determining that one or more of the identified recent query patterns are related to a predetermined list of entities comprises determining that the one or more identified recent query patterns are related to sequential items in the list of entities.

In other implementations identifying an entity that is associated with one or more search queries received during the search session comprises identifying the next entity in the list of entities.

In some implementations the list of entities is an unordered list of entities.

In some cases determining that one or more of the identified recent query patterns are related to a predetermined list of entities comprises determining that the one or more identified recent query patterns are related to items in the list of entities.

In other cases identifying an entity that is associated with one or more search queries received during the search session comprises identifying an entity in the list of entities.

In some implementations the query pattern database stores query patterns that have been extracted from search query logs.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIGS. 1A-1C depict an example system for providing suggested search queries based on one or more context terms.

FIG. 2 depicts a flowchart of an example process for providing suggested search queries based on one or more context terms.

FIGS. 3A and 3B depict a portion of an example user interface that provides suggested search queries based on one or more context terms using entity-based biasing.

FIGS. 4A to 4C depict a portion of an example user interface that provides suggested search queries based on one or more context terms using entity extrapolation.

Like reference symbols in the various drawings indicate like elements.

### DETAILED DESCRIPTION

This specification describes a system for using a search history during a search session to bias or extrapolate the scoring of potential suggested search queries towards places, people, or any entities that can be extracted from the search history. A system can receive search queries during a search session that include identifiers of entities, e.g., singers, actors, musicians, writers, directors, television networks, or other production companies. In response to receiving a request for a suggested search query during the search session, the system can select a query pattern e.g., “weather in $city,” “$country population 2014,” from a query pattern database, identify a placeholder type in the selected query pattern, e.g., “$city” or “$country”, identify an entity as a context term that matches the placeholder type and is associated with one or more search queries received during the search session, and generate a suggested search query. The system may perform entity-based biasing, wherein the system performs pattern based scoring and identifies high scoring entities that fit the pattern in the recent context. The system may also perform entity extrapolation by determining that many search queries are related to underlying lists, and by predicting a likely next search query based on an item in the underlying list.

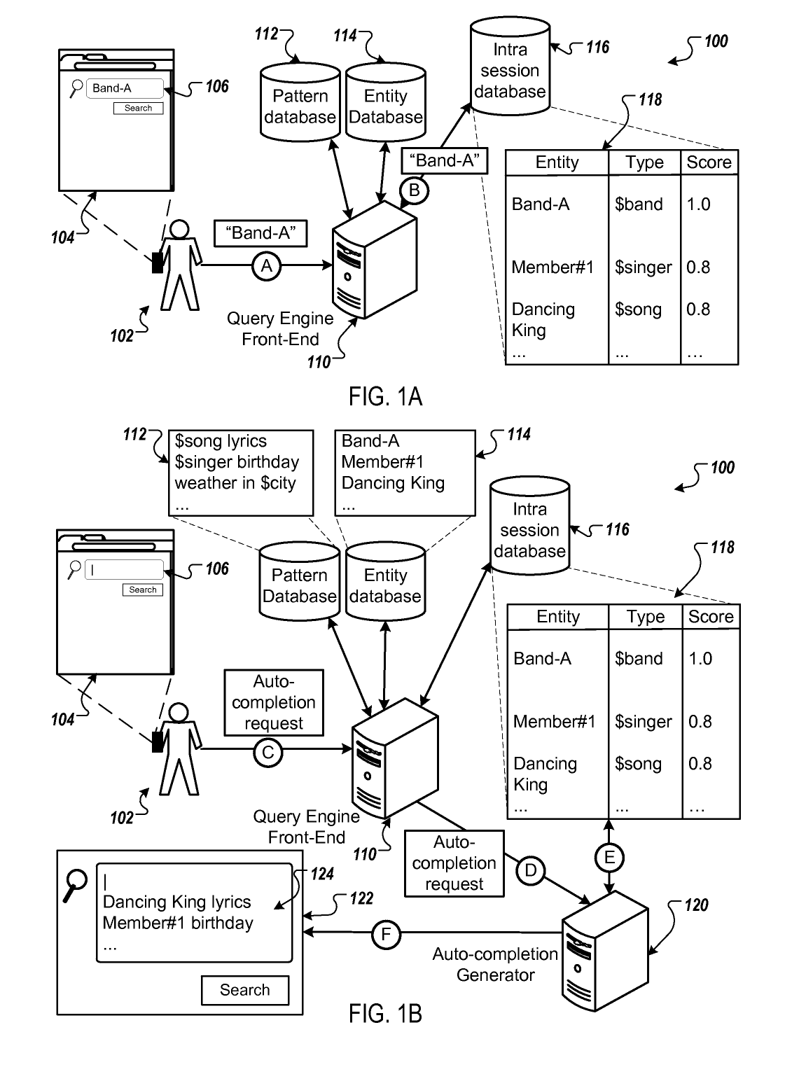

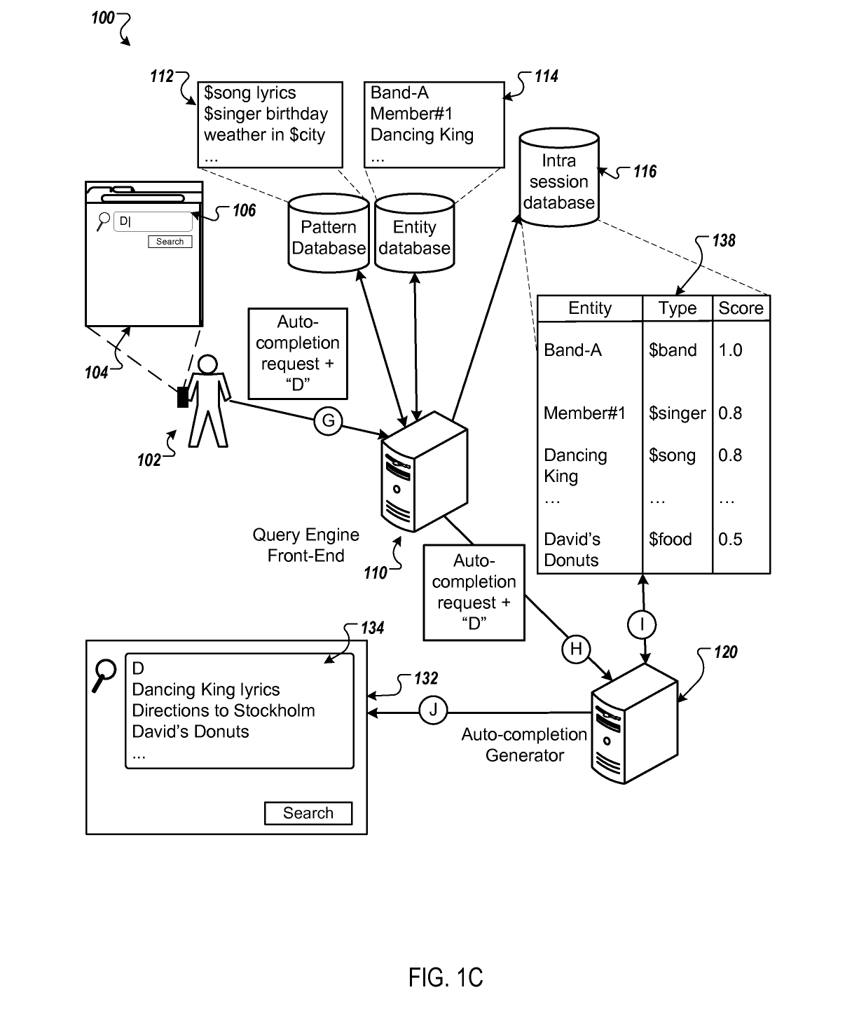

FIGS. 1A and 1B depict an example system 100 for providing suggested search queries based on one or more context terms. Specifically, the system 100 addresses an implementation in which a request for a suggested search query, i.e., an auto-completion of a search query, is received during a search session, and one or more suggested search queries are provided in response to the request, where the one or more suggested search queries are generated based upon one or more context terms that are extracted from search queries received during the search session.

Briefly, the system 100 can receive one or more search queries during a search session, such as one or more natural language queries input by a user. The system 100 can identify one or more entities referenced by the one or more search queries, and can select one or more query patterns referenced by the one or more search queries. The system 100 can generate suggested search queries based on identifying the one or more entities and selecting one or more query patterns referenced by the one or more search queries. A list of suggested search queries can be provided in response to the received request, e.g., as an output to the user by providing the list of suggested search queries in a search query entry field. The system 100 includes a client device 102, query engine front-end 110, pattern database 112, entity database 114, intra-session database 116 and auto-completion generator 120. The components of the system 100 can each be in communication over one or more networks, such as one or more LAN or WAN, or can be in communication through one or more other wired or wireless connections.

As depicted in FIG. 1A, during operation (A), i.e., during a search session, the query engine front-end 110 receives data encoding one or more search queries input by a user. For example, a user can provide the query “Band-A” at the client device 102, and data encoding the query can be received by the query engine front-end 110. In some implementations, the query engine front-end 110 can receive the data encoding the user-input query over one or more networks, or over one or more other wireless or wired connections.

The client device 102 can be a mobile computing device, such as a mobile phone, smart phone, personal digital assistant (PDA), music player, e-book reader, tablet computer, a wearable computing device, laptop computer, desktop computer, or other portable or stationary computing device. The client device 102 can feature a microphone, keyboard, touchscreen, or other interface that enables the user to input a query at the device. In some implementations, the user can provide the query at an interface that is presented or accessible from the client device 102. For example, the user can enter the query at a search engine that is accessible at the client device 102, can enter the query at a database that is accessible at the client device 102, or can provide the query at any other interface that features search capabilities, e.g., at a social network interface.

The user can provide a natural language query at the client device 102, such as by speaking one or more terms of a query, typing one or more terms of a query, selecting one or more terms of a search query, e.g., from a menu of available terms, selecting a query that comprises one or more terms, e.g., from a menu of available queries, or by providing a query using any other method. In other implementations, the user can provide a query using another method, for example, by selecting or submitting an image that the user would like to search for, by providing an audio or video sample of content that a user would like to search for, or by otherwise inputting a query at the client device 102.

Data that includes a query input by the user and that identifies one or more terms referenced by the query input by the user can be received by the query engine front-end 110 in a single data packet or in multiple data packets. The data associated with the user-input query can further be received simultaneously, or can be received separately at different times.

After receiving the data encoding the query input by the user, the query engine front-end 110 can transmit the data associated with the user input query to the intra-session database 116. For example, based on receiving data that includes the user-input search query “Band-A,” the query engine front-end 110 can extract the data associated with the user input query “Band-A” and can transmit data associated with the query to the intra-session database 116.

During operation (B), the intra-session database 116 can receive the information associated with the user-input query and can identify an entity associated with the user-input query. For example, the intra-session database 116 can receive information associated with the query “Band-A” and can identify an entity associated with the query as the band “Band-A.”

In some implementations, the intra-session database 116 can identify an entity associated with a query by comparing terms of the query to terms associated with a set of known entities. For example, the query received by the intra-session database 116 can be a natural language query, e.g., the query, “Band-A” and the intra-session database 116 can identify the entity “Band-A” as being associated with the query based on comparing the terms of the query to terms associated with a set of known entities. In some implementations, a known set of entities can be accessible to the intra-session database 116 at an entity database, such as entity database 114, that is associated with the intra-session database 116 or that is otherwise accessible to the intra-session database 116, e.g., over one or more networks.

In some implementations the intra-session database 116 can identify one or more entities that are related to the identified entity associated with the user-input query. For example, the query received by the intra-session database 116 can be a natural language query, e.g., the query, “Band-A” and the intra-session database 116 can identify one or more entities as being related to the query, such as the member of the band Band-A “Member#1,” or the song performed by the band Band-A “Dancing King.” In some implementations, the intra-session database 116 can identify one or more entities that are related to the identified entity associated with the user-input query using an entity database, such as entity database 114, that is associated with the intra-session database 116 or that is otherwise accessible to the intra-session database 116, e.g., over one or more networks.

Each entity identified by the intra-session database 116 can be assigned a relevance score. An entity may be assigned a relevance score based on numerous factors, such as how recently the entity was included in a user-input search query during a search session, e.g., was the entity included in the previous search query, how often the entity was included in user-input search queries during the search session, e.g., has the entity been included more than once during the search session, or how important the entity is deemed to be, e.g., based on how many views or clicks the entity or a resource associated with the entity has received. The relevance scores may be used to bias search query suggestions towards any entities that can be extracted from a user's recent search queries, and may be dynamically adjusted during the search session. In some instances the intra-session database 116 may assign the relevance scores to the entities, or the relevance score can be assigned to the entity by another system or assigned to the entity by a person, e.g., a moderator or user of the system 100.

In some implementations, the intra-session database 116 can identify types associated with an identified entity. For example, the query received by the intra-session database 116 can be a natural language query, e.g., the query, “Band-A” and the intra-session database 116 can identify the entity “Band-A” as being associated with the type “$band” and the related entity “Dancing King” as being associated with the type “$song.” Other examples of entity types include “$city,” “$singer,” or “$country,” to name a few. In some implementations, a known set of entities and their associated types can be accessible to the intra-session database 116 at an entity database, such as entity database 114, that is associated with the intra-session database 116 or that is otherwise accessible to the intra-session database 116, e.g., over one or more networks.

In some implementations, the intra-session database 116 can identify query patterns associated with a user-input query. For example, the query received by the intra-session database 116 can be a natural language query, e.g., the query, “dancing King lyrics Band-A” and the intra-session database 116 can identify the query pattern “$song lyrics $band.” Other examples of query patterns include “weather in $city,” “$singer birthday,” or “$country population 2014.” In some implementations, a known set of query patterns can be accessible to the intra-session database at a query pattern database, such as query pattern database 112, that is associated with the intra-session database 116 or that is otherwise accessible to the intra-session database 116, e.g., over one or more networks.

The intra-session database 116 can store information associated with the search session in a buffer 118, such as information related to each entity identified during the search session. For example, as depicted in FIG. 1A, the intra-session database 116 may store an entity identified from a user-input search query, e.g., “Band-A” together with an associated entity type, e.g., “$band” and relevance score “1.0.” In this example, the entity “Band-A” is assigned a relevance score of 1.0, since the current search query input by the user is “Band-A.” The intra-session database also stores information associated with the identified related entities “Member#1” and “Dancing King,” together with the associated entity types “$singer” and “$song,” respectively. In this example, the entities “Member#1” and “Dancing King” are each assigned the relevance score “0.8,” reflecting the connection of the entities to the current search query “Band-A.” In some implementations the intra-session database 116 may also store other information associated with the search session, such as identified received query patterns, or a search session search history.

As depicted in FIG. 1B, during operation (C), i.e. during the same search session, the query engine front-end 110 can receive a request for a suggested search query. For example, a user can begin a new search query at the client device 102, e.g., by clicking in a search query input field “|,” and data encoding the new query request can be received by the query engine front-end 110. In some implementations, the query engine front-end 110 can receive the data encoding the new query request over one or more networks, or over one or more other wireless or wired connections. The query engine front-end 110 can transmit the data encoding the new query request to the auto-completion generator 120.

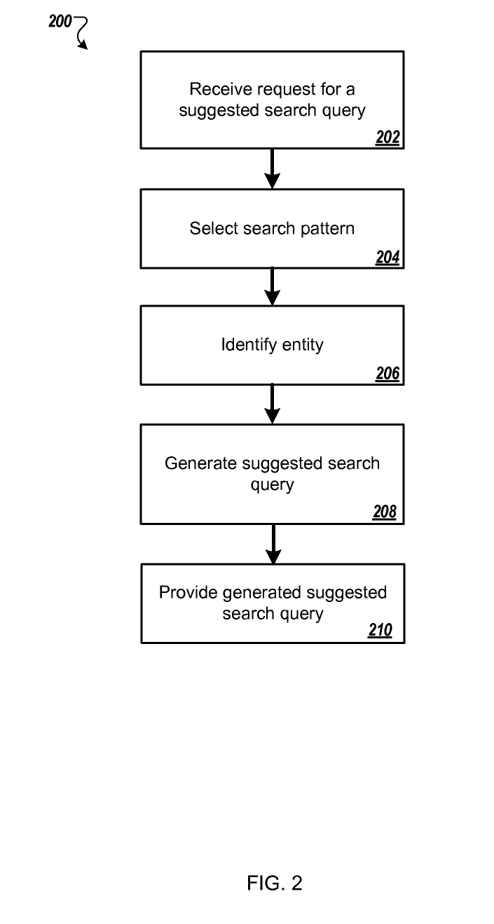

The auto-completion generator 120 can receive the data encoding the new query request from the query engine front-end 110 at operation (D). During operation (E), the auto-completion generator 120 can access the information stored in the intra-session database 116, as well as information stored in the pattern database 112 and entity database 114, in order to generate a suggested search query. For example, the auto-completion generator 120 may select a query pattern, e.g., “$song lyrics,” from the pattern database 112 and identify an entity that is associated with one or more search queries received during the search session, e.g., “Band-A,” from the buffer 118 in the intra-session database 116 in order to generate a suggested search query. Selecting query patterns and identifying entities in order to generate suggested search queries is described in more detail below with reference to FIG. 2.

During operation (F), the auto-completion generator 120 can provide data encoding one or more suggested search queries 124 to the client device 102 for presentation in a user interface 122. For example, as shown in FIG. 1B, based on one or more queries received during the search session, e.g., the search query “Band-A,” the auto-completion generator 120 has provided the suggested search queries “Dancing King lyrics” and “Member#1 birthday.”

As shown in FIG. 1C, during operation (G), the query engine front-end 110 can receive a request for a suggested search query, e.g., an auto-completion request. For example, as shown in FIG. 1C, a user may submit a partial search query, e.g., “D|,” at the client device 102, i.e., a search query that includes one or more characters, and data encoding the partial search query can be received by the query engine front-end 110. In some implementations, the query engine front-end 110 can receive the data encoding the partial search query over one or more networks, or over one or more other wireless or wired connections. The query engine front-end 110 can transmit the data encoding the partial search query to the auto-completion generator 120.

The auto-completion generator 120 can receive the data encoding the partial search query from the query engine front-end 110 at operation (H). During operation (I), the auto-completion generator 120 can access the information stored in the intra-session database 116, as well as information stored in the pattern database 112 and entity database 114, in order to generate an auto-completion of the partial search query. For example, the auto-completion generator 120 may determine that the partial search query matches a portion of a query pattern in the pattern database 112 and select the query pattern. Further, the auto-completion generator 120 may identify an entity that is associated with one or more search queries received during the search session, e.g., “Band-A,” from the buffer 138 in the intra-session database 116 in order to generate an auto-completion. In this example, the buffer 138 includes the entity “David's Donuts” with relevance score 0.5, reflecting that a query relating to “David's Donuts” may have been received during the search session, or is a likely query to be received by the user. Selecting query patterns and identifying entities that fit the pattern in a recent context in order to generate search query auto-completions is described in more detail below with reference to FIG. 2.

During operation (J), the auto-completion generator 120 can provide data encoding one or more suggested search queries 134 to the client device 102 for presentation in a user interface 132. For example, as shown in FIG. 1C, based on one or more queries received during the search session, e.g., the search query “Band-A,” and the partial search query “D|,” the auto-completion generator 120 has provided the suggested search queries “Dancing King lyrics” and “Directions to Stockholm,” (where it is assumed that the band “Band-A” originate from Stockholm.) In some implementations the suggested search queries may include suggestions that are related to entities other than the most recently received search query. For example, the suggested search queries 134 also include “David's Donuts,” reflecting that the user may have input a search query relating to “David's” and/or “Donuts” at some point during the search session.

FIG. 2 presents an example process 200 for providing suggested search queries based on one or more context terms. For example, the process 200 can be performed by the system 100 in response to receiving a request for a suggested search query.

At step 202, a request is received for a suggested search query. The request is received during a search session. In some implementations, the request for the suggested search query includes a partial search query that, in turn, includes one or more characters input by a user. For example, the request for the suggested search query may include the terms “weather in |.” In other implementations, the request for the suggested search query may not include any characters input by a user. For example, the request for the suggested search query may include an indication that the user has started a new search query, prior to the user inputting one or more characters, by clicking in the search query entry box.

At step 204, in response to receiving the request for the suggested search query, a query pattern is selected from a query pattern database. The query pattern database stores query patterns that have been extracted from search query logs. For example, the query patterns can be extracted in an offline job from search query logs, including a user's search history. A query pattern may include one or more placeholder terms that can be identified with certain types. For example, the query pattern “flights to $city” includes the placeholder term “$city” that is identified with a place or location. As another example, the query pattern “$song lyrics $bandname” includes the placeholder terms “$song” and “$bandname” which can be identified with a song and the name of a band, respectively.

As described above with reference to step 202, in some implementations the request for the suggested search query may include a partial search query. In such cases, selecting a query pattern from a query pattern database may include determining that the partial search query matches a portion of a query pattern stored in a query pattern database, and selecting the query pattern stored in the query pattern database. For example, the partial request for the suggested search query may include the terms “weather ink” In such cases, it may be determined that the partial search query “weather in|” matches a portion of the query pattern “weather in $city.”

In other implementations, selecting a query pattern from a query pattern database may include identifying one or more recent query patterns input during the search session, determining that one or more of the identified recent query patterns are related to a predetermined list of entities and selecting the query pattern that is determined to be related to the predetermined list of entities. For example, it may be identified that during the search session, a user may have recently input one or more instances of a query pattern, such as “$song1 lyrics $bandname” followed by “$song2 lyrics $bandname.” In such a case, it may be determined that the recent query patterns are related to consecutive songs in an album by a band, and a query pattern that is determined to be related to the list of songs in an album by the band may be selected.

In some implementations, the predetermined list of entities is an ordered list of entities. For example, as described in the above paragraph, the predetermined list of entities may be a list of songs in an album by a band. In such cases determining that one or more of the identified recent query patterns are related to a predetermined list of entities may include determining that the one or more identified recent query patterns are related to sequential items in the list of entities.

In other implementations, the predetermined list of entities is an unordered list of entities. For example, the predetermined list of entities may be a list of actors or actresses appearing in a film, or a list of countries in Europe. In such cases determining that one or more of the identified recent query patterns are related to a predetermined list of entities may include determining that the one or more identified recent query patterns are related to items in the list of entities.

At step 206, in response to receiving the request for the suggested search query, an entity that is associated with one or more search queries received during the search session is identified. In some implementations, a set of entities referenced by one or more search queries received during the search session may be identified. For each entity in the set of entities referenced by the one or more search queries, one or more expansion entities that are related to the entity may be identified, and the set of entities may be expanded to include the expansion entities that are related to each entity in the set of entities. Each entity in the expanded set of entities may be assigned a respective relevance score. The expanded set of entities may be stored in a buffer, and the entity that is associated with one or more search queries received during the search session may identified from among the expanded set of entities stored in the buffer.

In some implementations, identifying an entity that is associated with one or more search queries received during the search session includes identifying an entity type matching a placeholder type in the selected query pattern, and identifying an entity that (i) has the identified entity type, and (ii) is associated with one or more search queries received during the search session. For example, the system may identify the entity type “$city” as matching the placeholder type “$city” in the query pattern “weather in $city,” and identify the entity “Happytown” as having the entity type “$city” and being associated with one or more search queries received during the search session.

In some implementations, identifying an entity that (i) has the identified entity type, and (ii) is associated with one or more search queries received during the search session includes accessing the expanded set of entities stored in the buffer, selecting a set of entities that have the identified entity type, and selecting an entity from the selected set of entities based on the relevance scores of each entity in the selected set of entities that have the identified entity type. For example, the system may access the expanded set of entities stored in the buffer, and select a set of entities that have the type “$city.” The system may then select a particular entity, i.e., a particular city name, from the set of entities that have the type “$city” based on the relevance scores of the entities that have the type “$city.” If the user has recently input search queries relating to the entity “Happytown,” e.g., “flights to Happytown,” the entity “Happytown” may have a higher relevance score than another city that the user has not recently included in any search queries.

In some cases, as described above with reference to step 204, a set of entities with a particular type may be an ordered list of entities, such as a list of songs in an album by a band. In such cases, identifying an entity that is associated with one or more search queries received during the search session includes identifying the next entity in the list of entities. For example, if the user has input one or more search queries relating to the first two songs in an album by a band, the system may identify the third song in the album by the band as the entity that is associated with one or more search queries received during the search session.

In other cases, as described above with reference to step 204, a set of entities with a particular type may be an unordered list of entities, such as a list of actors or actresses appearing in a film. In such cases, identifying an entity that is associated with one or more search queries received during the search session includes identifying an entity in the list of entities. For example, if the user has input one or more search queries relating to two actors appearing in a film, the system may identify a third actor or actress appearing in the film as the entity that is associated with one or more search queries received during the search session.

At step 208, in response to receiving the request for the suggested search query, based on the selected query pattern and the identified entity, a suggested search query is generated.

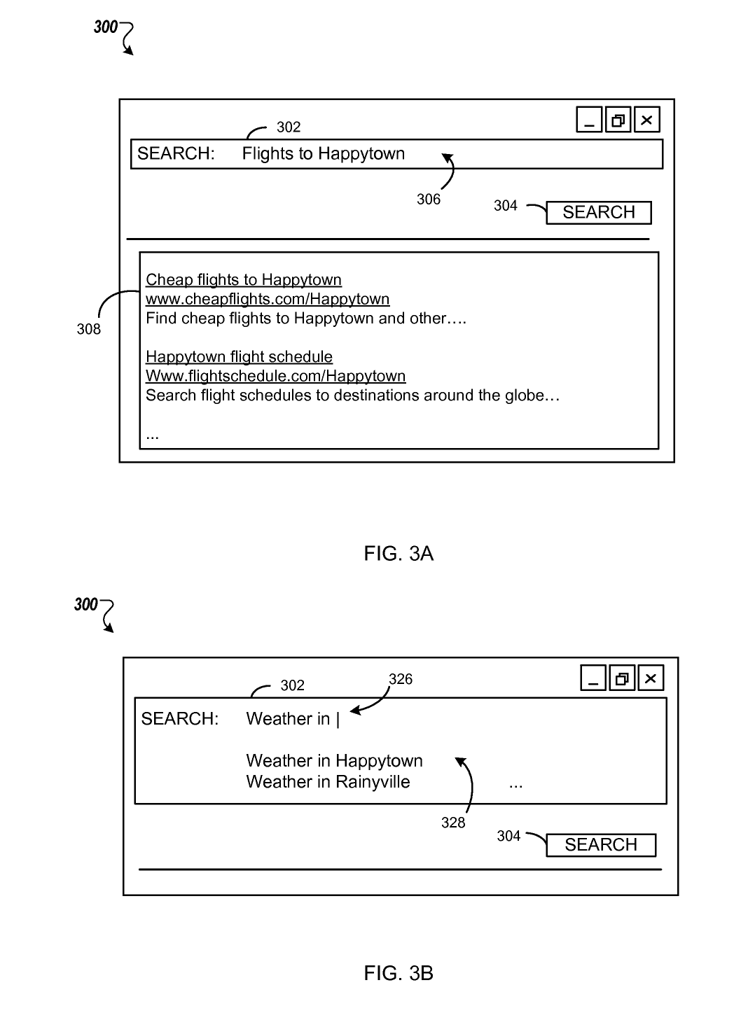

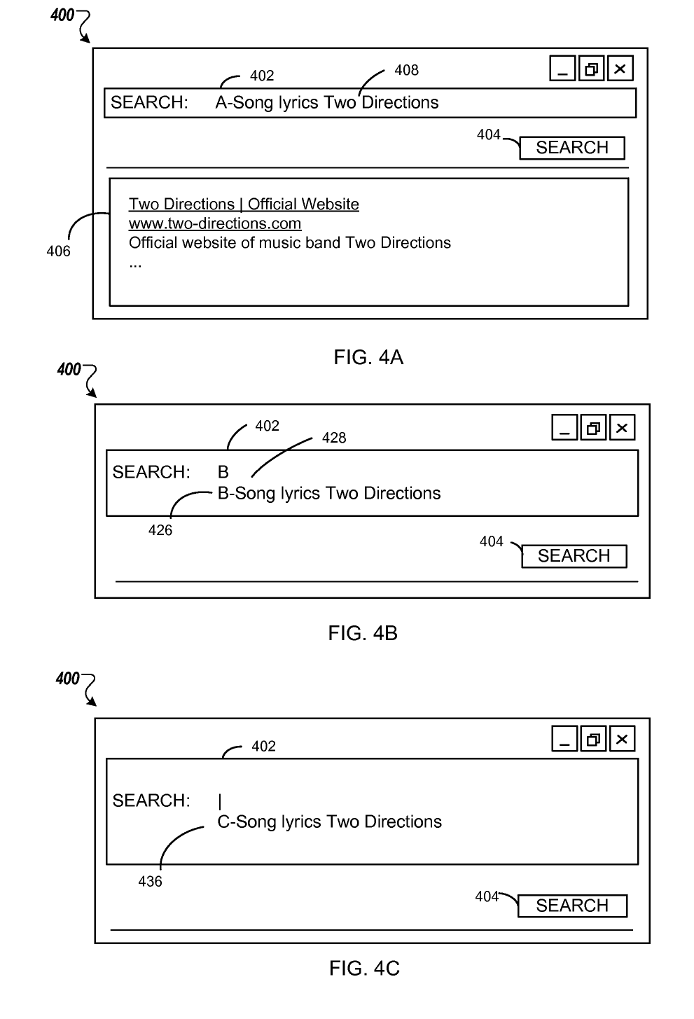

At step 210, in response to receiving the request for the suggested search query, the generated suggested search query is provided. Presentations of user interfaces that provide suggested search queries based on one or more context terms using entity-based biasing and entity extrapolation are described in more detail below with reference to FIGS. 3A-3B and 4A-4C.

FIGS. 3A and 3B illustrate a portion of an example user interface 300 that provides suggested search queries based on one or more context terms using entity-based biasing. The user interface 300 can be presented to users during a search session. In some implementations, the user interface 300 can be presented in a web browser or other application that is capable of providing users with a query feature, e.g., in search results pages provided by a search engine that is accessible to users via a web browser.

The user interface 300 as depicted in FIG. 3A is representative of a user interface for displaying search results in response to a query input by a user. In some implementations, the user interface 300 as depicted in FIG. 3A can be presented to a user in response to the user providing a query at a search engine or other system that enables users to provide requests for information. Briefly, the user interface 300 includes a query entry field 302, a query request control 304 and search results 308.

The user interface 300 as depicted in FIG. 3A can be presented in response to a query input by a user during a search session. For example, as shown in FIG. 3A, a user has input the search query 306 “flights to Happytown” at the query entry field 302, and the user interface 300 can be presented to the user in response to the user selecting the query request control 304. The user interface 300 presents search results 308 that are relevant to the query “flights to Happytown.” For example, as shown in FIG. 3A, the search results 308 include results for an online service for booking flights to Happytown and a website detailing flight schedule information for Happytown.

The user interface 300 as depicted in FIG. 3B is a representative user interface for displaying suggested search queries in response to a partial query input by a user at a later time during the same search session using entity-based biasing. For example, as shown in FIG. 3B, a user has input the partial search query 326 “Weather in|” at the query entry field 302. In some implementations the user may not input a partial search query, but start a new search query by clicking on the query entry field, as described above with reference to FIG. 2.

Based on identifying at least the entity “Happytown” as an entity that is associated with one or more search queries received during the search session, the user interface 300 as depicted in FIG. 3B presents a list of suggested search queries 328 that are relevant to the partial search query “weather in|” and previous search queries input by the user during the search session. For example, as shown in FIG. 3B, the list of suggested search queries 328 includes “Weather in Happytown” and “Weather in Rainyville.” The suggested search query “Weather in Happytown” appears higher in the list of suggested search queries than the suggested search query “Weather in Rainyville,” since a previous search query input by the user during the search session included the query “flights to Happytown,” as shown in FIG. 3A. The city context term “Happytown” therefore has a higher relevance score than other cities in the set of possible suggestions, e.g., a user's hometown.

FIGS. 4A to 4C illustrate a portion of an example user interface that provides suggested search queries based on one or more context terms using entity extrapolation. The user interface 400 can be presented to users during a search session. In some implementations, the user interface 400 can be presented in a web browser or other application that is capable of providing users with a query feature, e.g., in search results page provided by a search engine that is accessible to users via a web browser.

The user interface 400 as depicted in FIG. 4A is representative of a user interface for displaying search results in response to a query input by a user. In some implementations, the user interface 400 as depicted in FIG. 4A can be presented to a user in response to the user providing a query at a search engine or other system that enables users to provide requests for information. Briefly, the user interface 400 includes a query entry field 402, a query request control 404 and search results 406.

The user interface 400 as depicted in FIG. 4A can be presented in response to a query input by a user during a search session. For example, as shown in FIG. 4A, a user has input the search query “A-Song lyrics Two Directions” at the query entry field 402, and the user interface 400 can be presented to the user in response to the user selecting the query request control 404. The user interface 400 presents search results 406 that are relevant to the query “A-Song lyrics Two Directions.” For example, as shown in FIG. 4A, the search results 406 include results for the official website of the band “Two Directions.”

The user interface 400 as depicted in FIG. 4B is representative of a user interface for displaying suggested search queries in response to a partial query input by a user at a later time during the same search session. For example, as shown in FIG. 4B, a user has input the partial search query “B|” at the query entry field 402. In some implementations the user may not input a partial search query, but start a new search query by clicking on the query entry field, as described above with reference to FIG. 2. Based on identifying at least the entities “Two Directions” and “A-Song” in a recent search query input by the user, the user interface 400 as depicted in FIG. 4B presents a suggested search query 426 that is relevant to both the partial search query “B” and previous search queries input by the user during the search session. For example, as shown in FIG. 4B, the suggested search query 426 is “B-Song lyrics Two Directions.”

The user interface 400 as depicted in FIG. 4C is representative of a user interface for displaying suggested search queries in response to a user starting a new search query during the same search session using entity extrapolation. For example, as shown in FIG. 4C, a user has begun a new search query by clicking on the query entry field 402. Based on identifying the query pattern “$song lyrics $bandname” in one or more recent search queries input by the user, e.g., search queries 408 and 428 in FIGS. 4A and 4B, respectively, and determining that the pattern “$song lyrics $bandname” is related to a predetermined list of songs in an album by a band, the user interface 400 as depicted in FIG. 4C presents a suggested search query 436. For example, as shown in FIG. 4C, the system has identified the search query pattern “$song lyrics $bandname,” identified the predetermined list of songs in an album by the band “Two Directions,” selected a third song “C-Song” from the predetermined list of songs and generated the suggested search query “C-Song lyrics Two Directions.”

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

For instances in which the systems and/or methods discussed here may collect personal information about users, or may make use of personal information, the users may be provided with an opportunity to control whether programs or features collect personal information, e.g., information about a user's social network, social actions or activities, profession, preferences, or current location, or to control whether and/or how the system and/or methods can perform operations more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained, such as to a city, ZIP code, or state level, so that a particular location of a user cannot be determined. Thus, the user may have control over how information is collected about him or her and used.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular embodiments have been described. Other embodiments are within the scope of the following claims. For example, the actions recited in the claims may be performed in a different order and still achieve desirable results.

What is claimed is:

1. A computer implemented method comprising:
receiving, during a search session, a request for a suggested search query;
in response to receiving the request for a suggested search query:
selecting a query pattern from a query pattern database;
identifying an entity that is associated with one or more search queries received during the search session;
generating a suggested search query based on the selected query pattern and the identified entity; and
providing data that causes the generated suggested search query to be presented in a user interface.

2. The method of claim 1, comprising:
identifying a set of entities referenced by one or more search queries received during the search session;
for each entity in the set of entities, identifying one or more entities that are related to the entity;
expanding the set of entities to include the entities that are related to each entity in the set of entities; and
storing, in a buffer, the expanded set of entities, wherein the entity is identified from among the expanded set of entities stored in the buffer.

3. The method of claim 2, comprising, for each entity in the expanded set of entities, assigning a relevance score to the entity.

4. The method of claim 2, wherein identifying an entity that is associated with one or more search queries received during the search session comprises:
identifying an entity type matching a placeholder type in the selected query pattern; and
identifying an entity that (i) has the identified entity type, and (ii) is associated with one or more search queries received during the search session.

5. The method of claim 4, wherein identifying an entity that (i) has the identified entity type, and (ii) is associated with one or more search queries received during the search session comprises:
accessing, by the buffer, the expanded set of entities;
selecting a set of entities that have the identified entity type;
selecting an entity from the set of entities based on the scores of each entity in the set of entities that have the identified entity type.

6. The method of claim 1, wherein the request for the suggested search query comprises a partial search query that includes one or more characters input by a user.

7. The method of claim 6, wherein selecting the query pattern comprises:
determining that the partial search query matches a portion of a query pattern stored in a query pattern database;
selecting the query pattern stored in the query pattern database.

8. The method of claim 1, wherein the request for the suggested search query does not include any characters input by a user.

9. The method of claim 1, wherein selecting the pattern comprises:
identifying one or more recent query patterns input during the search session;
determining that one or more of the identified recent query patterns are related to a predetermined list of entities;
selecting the query pattern that is determined to be related to the predetermined list of entities.

10. The method of claim 9, wherein the list of entities is an ordered list of entities.

11. The method of claim 10, wherein determining that one or more of the identified recent query patterns are related to a predetermined list of entities comprises determining that the one or more identified recent query patterns are related to sequential items in the list of entities.

12. The method of claim 11, wherein identifying an entity that is associated with one or more search queries received during the search session comprises identifying the next entity in the list of entities.

13. The method of claim 9, wherein the list of entities is an unordered list of entities.

14. The method of claim 13, wherein determining that one or more of the identified recent query patterns are related to a predetermined list of entities comprises determining that the one or more identified recent query patterns are related to items in the list of entities.

15. The method of claim 14, wherein identifying an entity that is associated with one or more search queries received during the search session comprises identifying an entity in the list of entities.

16. The method of claim 1, wherein the query pattern database stores query patterns that have been extracted from search query logs.

17. A system comprising:
one or more computers and more or more storage devices storing instructions that are operable, when executed by the one or more computers, to cause the one or more computers to perform operations comprising:
receiving, during a search session, a request for a suggested search query;
in response to receiving the request for a suggested search query:
selecting a query pattern from a query pattern database;
identifying an entity that is associated with one or more search queries received during the search session;
generating a suggested search query based on the selected query pattern and the identified entity; and
providing data that causes the generated suggested search query to be presented in a user interface.

18. The system of claim 17, comprising:
identifying a set of entities referenced by one or more search queries received during the search session;
for each entity in the set of entities, identifying one or more entities that are related to the entity;
expanding the set of entities to include the entities that are related to each entity in the set of entities; and
storing, in a buffer, the expanded set of entities, wherein the entity is identified from among the expanded set of entities stored in the buffer.

19. The system of claim 17, wherein identifying an entity that is associated with one or more search queries received during the search session comprises:
identifying an entity type matching a placeholder type in the selected query pattern; and
identifying an entity that (i) has the identified entity type, and (ii) is associated with one or more search queries received during the search session.

20. A computer-readable storage device encoded with a computer program, the program comprising instructions that, if executed by one or more computers, cause the one or more computers to perform operations comprising:
receiving, during a search session, a request for a suggested search query;
in response to receiving the request for a suggested search query:
selecting a query pattern from a query pattern database;
identifying an entity that is associated with one or more search queries received during the search session;
generating a suggested search query based on the selected query pattern and the identified entity; and
providing data that causes the generated suggested search query to be presented in a user interface.
